(19) United States
(12) Patent Application Publication
(10) Pub. No.: US 2026/0079719 A1
(43) Pub. Date: Mar. 19, 2026

(54) METHOD AND SYSTEM FOR AUTOMATICALLY CONFIGURING HARDWARE RESOURCES OF DRIVER, AND STORAGE MEDIUM

(71) Applicant: PAX COMPUTER TECHNOLOGY (SHENZHEN) CO., LTD., Shenzhen (CN)

(72) Inventors: Lihong XIE, Shenzhen (CN); Zhefeng LAI, Shenzhen (CN); Xuehui XIAO, Shenzhen (CN); Haicheng SUO, Shenzhen (CN)

(21) Appl. No.: 19/110,911

(22) PCT Filed: Jul. 27, 2023
(86) PCT No.: PCT/CN2023/109669

§ 371 Date: Mar. 12, 2025

(30) Foreign Application Priority Data
Sep. 14, 2022 (CN) 202211114978.1

(51) Int. Cl. G06F 9/4401; G06F 9/445

(52) U.S. Cl. CPC G06F 9/4415; G06F 9/44521

(57) ABSTRACT

A method for automatically configuring hardware resources of a driver, includes: reading device model information in a configuration file; matching corresponding hardware resource configuration information and a loading function of the hardware resource configuration information according to the device model information, the hardware resource configuration information including description information of the hardware resources; and executing the loading function of the hardware resource configuration information, and loading the hardware resource configuration information into the driver.

The present disclosure claims priority of Chinese Patent Application No. 202211114978.1, entitled “a method, a device, and a system for automatically configuring hardware resources of a driver, and a storage medium”, filed on Sep. 14, 2022 in the China National Intellectual Property Administration, the entire contents of which are incorporated by reference herein.

### TECHNICAL FIELD

The present disclosure herein generally relates to a technical field of hardware resource configuration, and particularly to a method, a device, and a system for automatically configuring hardware resources of a driver, and a storage medium.

### BACKGROUND

The Zephyr Project is a collaborative project hosted by the Linux Foundation, an open source collaboration that unites industry leaders to build the best small, scalable Real-Time Operating System (RTOS) optimized for all resource-constrained devices.

A chip will be used to develop multiple types of devices, and each type of device will have different configurations due to different market positioning or functional focus; the same model of device may also have multiple different configurations, and due to different configurations, the allocation of hardware resources on the chip will change. Generally speaking, the device driver needs to know what hardware resources it uses in order to drive the device normally. In Zephyr's device driver framework, the “device tree” description method is used to specify the hardware resources used by the driver, that is, to retain the device information existing in the system. When the machine boots, the platform builds this tree by using the information obtained by the driver and other components, and updates this tree when devices are added or removed.

In the existing Zephyr system, the hardware resources obtained by the driver are fixed during the software compilation stage. Therefore, the driver is only allowed to use a certain hardware resource and cannot be dynamically configured and modified during the software operation. Only one set of software can be released for the hardware resource configuration of a certain device, resulting in a large number of released software versions and a heavy workload for the management and maintenance of different software versions.

### BRIEF DESCRIPTION OF THE DRAWINGS

In order to more clearly state the technical solution in the embodiment of the present disclosure, the following is a brief introduction of the drawings required to be used in the description of the embodiment or the prior art, it is obvious that the drawings described below are only some embodiments of the present disclosure, for those skilled in the art, other drawings can also be obtained from these drawings without creative efforts.

FIG. 1 is a schematic view of an embodiment of an architecture of a method for configuring hardware resources of a driver in the existing Zephyr system according to the present disclosure;

FIG. 2 is a flowchart of an embodiment of a method for configuring hardware resources of a driver according to the present disclosure;

FIG. 3 is a schematic view of an embodiment of an architecture of the method for configuring hardware resources of a driver according to the present disclosure;

FIG. 4 is a structural schematic view of an embodiment of the driver according to the present disclosure;

FIG. 5 is a schematic view of an embodiment of a device for configuring hardware resources of a driver according to the present disclosure;

FIG. 6 is a schematic view of an embodiment of a system for configuring hardware resources of a driver according to the present disclosure.

### EMBODIMENTS OF THE PRESENT DISCLOSURE

In the following description, specific details such as specific system structures, technologies, etc. are provided for a purpose of illustration rather than limitation, so as to provide a thorough understanding of the embodiments of the present disclosure. However, it should be clear to those skilled in the art that, the present disclosure may also be implemented in other embodiments without these specific details. In other cases, detailed descriptions of well-known systems, devices, circuits, and methods are omitted to prevent unnecessary details from obstructing the description of the present disclosure.

In order to illustrate the technical solutions described in present disclosure, specific embodiments are provided below for illustration.

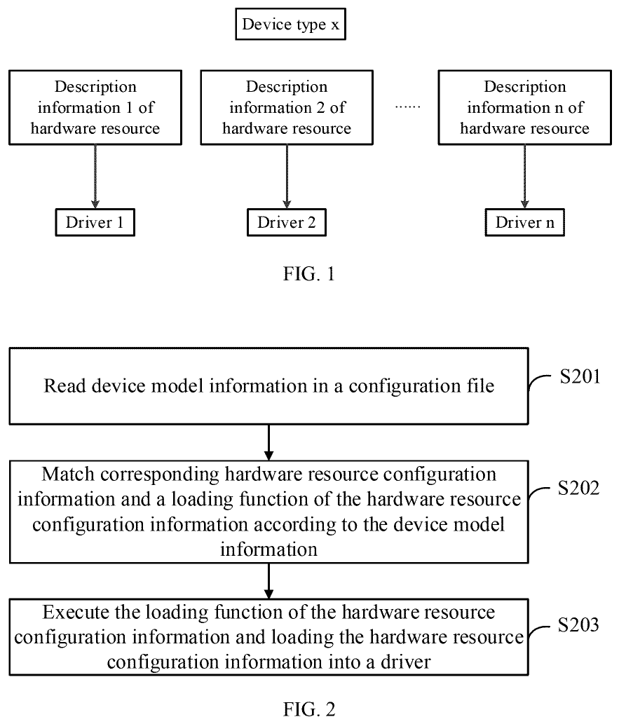

A chip is generally used to develop a number of models of devices, the number of models of devices has different configurations due to different market positioning or functional focus; at the same time, the same model of devices may have multiple different configurations, therefore, the allocation of hardware resources on the chip may change due to different models or different configurations of the same model. As illustrated in FIG. 1, in the existing device driver framework of Zephyr (Internet of Things operation system), the driver is only allowed to use a certain specified hardware resource, the hardware resources are fixed during a software compilation stage of the Zephyr, and cannot be dynamically configured and modified during the software operation process, that is, for devices of different models or different configurations of the same model, different software versions can only be developed according to the different configured hardware resources, which results in too many software versions and a large workload of management and maintenance.

Based on the problems existing in the prior art, the present disclosure provides a method, and a system for automatically configuring hardware resources of a driver, and a storage medium, which integrates different hardware resources of devices of multiple different models and devices of the same model with different configurations, and loads the hardware resource configuration information corresponding to the read device model information into the driver, the driver can automatically adapt to the hardware resource configuration of the device, a set of software is suitable for devices of different models and different configurations, thereby reducing the number of released software version and the maintenance workload.

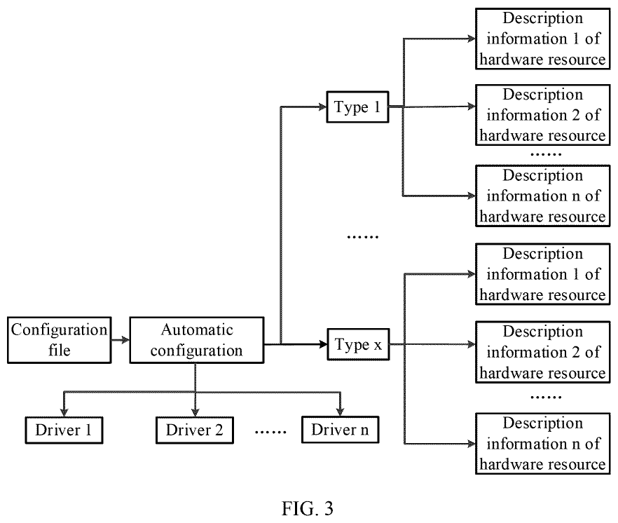

As illustrated in FIG. 2 and FIG. 3, the first aspect of the present disclosure provides a method for automatically configuring hardware resources of a driver, the method include the following steps:

Step S201, reading device model information in a configuration file;

The embodiment of the present disclosure is based on the Zephyr system, and a set of software suitable for devices of different models and devices of the same model with different configurations is designed, to enable the driver to automatically configure the corresponding hardware resources, for the devices of different models or different configurations of devices of the same model, the embodiment of the present disclosure provides device model information including a device name, a hardware version number, and a hardware interface version number, it can be understood that, the devices of different models and the same model may apply different board levels (i.e., PCB boards), and the devices of the same model may also include a number of board levels, each board level corresponds to a hardware, and each board level has hardware resource description information about the board level, to record the hardware resource condition. Therefore, it is necessary to automatically configure according to the device model and the hardware resources corresponding to the required board level in the device, the hardware refers to the board level of the hardware resources required by the driver, and the hardware interface is the board level that connects the driver with the required hardware resources.

Before step S201, in order to enable the driver to configure the required hardware resource configuration information, first, as illustrated in FIG. 3, it is necessary to integrate multiple hardware resources of different models and different configurations of the same model, and integrate the multiple hardware resources into hardware resource configuration information corresponding to the device model information, each hardware resource configuration information includes description information of one or more hardware resources, for example, the description information of the hardware resources includes but is not limited to a series of information such as GPIO number (i.e., pin number), SPI parameter information, screen, card swiping, printer, etc., there is no coupling relationship between the integrated hardware resource configuration information in the embodiment of the present disclosure, and the hardware resource configuration information are independent of each other, which facilitate adjusting different hardware resources, adjusting any hardware resource configuration will not affect other hardware resources;

Then, a configuration file is provided for each device model information, by reading the device model information in the configuration file and combining with a configuration file parsing library, the corresponding device name, hardware version number, and hardware interface version number can be obtained, for example, by reading and parsing the device model information of the configuration file, a serial number “A3700_V01_V01” including the device name, hardware version number, and hardware interface version number is obtained, and the hardware resource configuration information corresponding to the device model information can be matched.

Step S202, matching corresponding hardware resource configuration information and a loading function of the hardware resource configuration information according to the device model information, the hardware resource configuration information includes description information of the hardware resources;

In step S202, in order to configure the matched hardware resource configuration information into the driver, the embodiment of the present disclosure creatively provides the loading function of the corresponding hardware resource configuration information for each device model information, and the corresponding hardware resource configuration information can be matched according to the device model information, and the loading function of the corresponding hardware resource configuration information can be obtained, by executing the loading function of the hardware resource configuration information, the hardware resource configuration information can be loaded into the driver. It can be understood that, the loading function of the hardware resource configuration information is an initialization function, that is, in each configuration process, the device model information of the configuration file is re-read, the loading function of the corresponding hardware resource configuration information is re-obtained, and the hardware resource configuration information is re-configured for the driver.

Step S203, executing the loading function of the hardware resource configuration information, and loading the hardware resource configuration information into the driver.

In one embodiment, step S203 specifically includes: executing the loading function of the hardware resource configuration information, invoking an injection function of the driver, a pointer of the injection function of the driver pointing to a position of the hardware resource configuration information; loading the hardware resource configuration information into the driver, according to the injection function of the driver.

In step S203, in order to configure the matched hardware resource configuration information into the driver, the embodiment of the present disclosure creatively improves a driver structure of the Zephyr system, and adjusts an original driver structure of the Zephyr system from pointing to a fixed position to pointing to a global variable, when the software is running, the global variable is assigned a corresponding value according to the device model information, and points to the position of the hardware resource configuration information corresponding to the device model information, and the hardware resource configuration information is correctly loaded into the driver, which solves the problem that the driver can only use a specified hardware resource in the prior art, and realizes dynamic configuration or modification of the hardware resource configuration during the software operation process. The improvement of the driver structure is specifically provided by providing the injection function in the driver, and the pointer of the injection function is correctly point to the position of the hardware resource configuration information, so as to inject the correct hardware resource configuration information into each driver.

In one embodiment, loading the hardware resource configuration information into the driver includes: configuring the description information of one or more hardware resources in the hardware resource configuration information into one or more hardware resource structure bodies; and loading the one or more hardware resource structure bodies into the structure body of the driver.

In one embodiment, the structure body of the driver includes a data structure body and a configure structure body, the hardware resource structure body includes a data substructure body and a configure substructure body, and loading the one or more hardware resource structure bodies into the structure body of the driver includes: loading the one or more of the data substructure bodies into the data structure body of the driver, and loading the one or more of configure substructure bodies into the configure structure body of the driver accordingly.

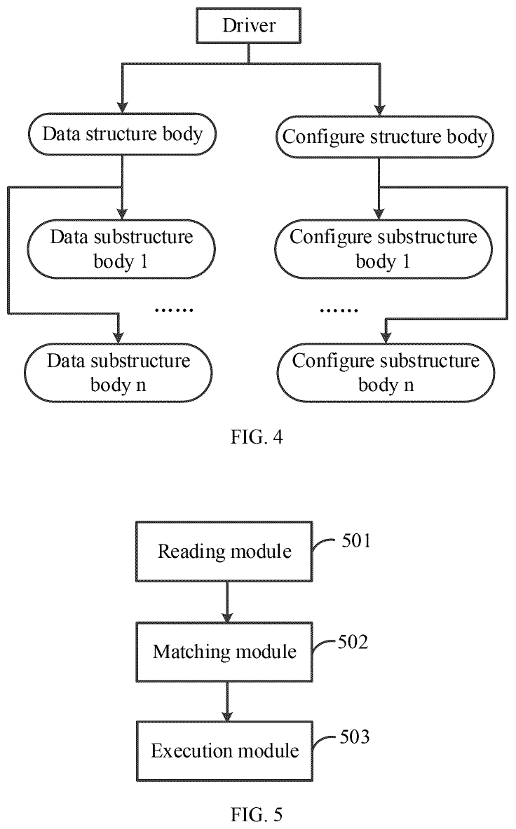

As illustrated in FIG. 4, each driver of the Zephyr system includes a data structure body and a configure structure body, the data structure body is used to store the variables used by the driver, and the configure structure body includes the description information of all the hardware resources of the driver. Therefore, loading the hardware resource configuration information into the driver means loading the hardware resource configuration information into the data structure body and the configure structure body of the driver, since the hardware resource configuration information includes the description information of one or more hardware resources, the description information of the one or more hardware resources is first configured into one or more hardware resource structure bodies, each hardware resource structure includes a data substructure body and a configure substructure body, then, the data substructure body is loaded into the data structure body of the driver, and the configure substructure body is loaded into the configure structure body of the driver.

It should be noted that, if a certain hardware resource is not required in actual use, the memory of the corresponding data structure body can be deleted, to save memory, and reduce the memory overhead of the entire software.

In one implementation, after the hardware resource configuration information is loaded into the driver, the method further includes: executing a driving process of the driver in the Zephyr system.

After the hardware resource configuration information is loaded into the driver, the Zephyr system continues to load the driver and execute the driving process of the driver according to a normal loading process without any adjustments, it can be seen that, the embodiment of the present disclosure achieves the effect of automatic configuration of the hardware resources of the driver without modifying the codes of the Zephyr system, which facilitates the subsequent upgrade synchronization of the codes of the Zephyr system.

It should be understood that, the serial numbers of the steps in the above embodiments do not indicate the execution sequence, the execution sequence of each process should be determined according to the function and internal logic, and should not constitute any limitation on the implementation process of the embodiments of the present disclosure.

Referring to FIG. 5, a second aspect of the embodiment of the present disclosure provides a device for automatically configuring hardware resources of a driver, the device includes:
a reading module 501, configured to read device model information in the configuration file
a matching module 502, configured to match the corresponding hardware resource configuration information and the loading function of the hardware resource configuration information according to the device model information, the hardware resource configuration information includes description information of the hardware resources;
an execution module 503, configured to execute the loading function of the hardware resource configuration information, and load the hardware resource configuration information into the driver.

In one embodiment, the execution module 503 is further configured to: execute the loading function of the hardware resource configuration information, invoke the injection function of the driver, the injection function pointer of the driver points to the position of the hardware resource configuration information; load the hardware resource configuration information into the driver, according to the injection function of the driver.

In one embodiment, loading the hardware resource configuration information into the driver includes: configuring the description information of one or more hardware resources in the hardware resource configuration information into one or more hardware resource structure bodies; and loading one or more hardware resource structure bodies into the structure body of the driver.

In one embodiment, the structure body of the driver includes a data structure body and a configure structure body, and the hardware resource structure body includes a data substructure body and a configure substructure body.

Loading one or more of the hardware resource structure bodies into the structure body of the driver includes: loading the one or more of the data substructure bodies into the data structure body of the driver, and loading the one or more of configure substructure bodies into the configure structure body of the driver accordingly.

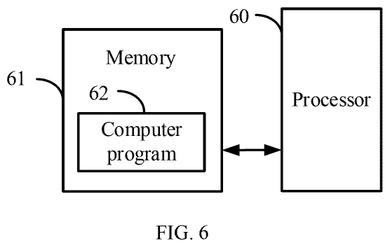

Referring to FIG. 6, a third aspect of the embodiment of the present disclosure provides a system for automatically configuring hardware resources of a driver, the system includes a memory 61, a processor 60, and a computer program 62 stored in the memory 61 and executable on the processor 60, when the processor 60 executes the computer program 62, the steps of the above-mentioned method for automatically configuring hardware resources of the driver are implemented. When the processor 60 executes the computer program 62, the functions of each module/unit in each device embodiment are implemented.

A fourth aspect of the embodiment of the present disclosure provides a computer-readable storage medium, the computer-readable storage medium stores a computer program, and when the computer program is executed by a processor, the steps of the above-mentioned method for automatically configuring hardware resources of the driver are implemented. When the processor executes the computer program, the functions of each module/unit in each device embodiment are implemented.

The one skilled in the art can clearly understand that, for the convenience and simplicity of description, the division of the above-mentioned functional units and modules is used as an example for illustration, in actual applications, the above-mentioned function allocation can be completed by different functional units and modules as required, that is, the internal structure of the device can be divided into different functional units or modules, to realize all or part of the functions described above. The functional units and modules in the embodiment can be integrated in a processing unit, or each unit can exist physically separately, or two or more units can be integrated in one unit, the above-mentioned integrated unit can be implemented in a form of hardware, or in a form of software functional units. In addition, the specific names of the functional units and modules are only for the convenience of distinguishing each other, and are not used to limit the scope of protection of present disclosure. The specific working process of the units and modules in the above-mentioned system can refer to the corresponding process in the aforementioned method embodiment, which is not repeated.

In the above embodiments, the description of each embodiment has its own emphasis, for parts that are not described or recorded in detail in a certain embodiment, reference can be made to the relevant descriptions of other embodiments.

The one skilled in the art can understand that, the units and algorithm steps of each example described in conjunction with the embodiments disclosed herein can be implemented in electronic hardware, or a combination of computer software and electronic hardware. Whether these functions are performed in hardware or software depends on the specific application and design constraints of the technical solution. Professional and technical personnel can use different methods to implement the described functions for each specific application, but such implementation should not be considered to be beyond the scope of present disclosure.

In the embodiments provided in the present disclosure, it should be understood that the disclosed devices/terminal equipment and methods can be implemented in other ways. For example, the device/terminal equipment embodiments described above are only schematic, for example, the division of the modules or units is only a logical function division, there may be other division methods in actual implementation, such as multiple units or components can be combined or integrated into another system, or some features can be ignored or not executed. Another point is that the mutual coupling or direct coupling or communication connection shown or discussed can be through some interfaces, indirect coupling or communication connection of devices or units, which can be electrical, mechanical or other forms.

The units described as separate components may or may not be physically separated, and the components shown as units may or may not be physical units, that is, they may be located in one place or distributed on multiple network units. Some or all of the units may be selected according to actual requirement to achieve the purpose of the solution of the embodiment.

In addition, each functional unit in each embodiment of the present disclosure may be integrated into one processing unit, or each unit may exist physically separately, or two or more units may be integrated into one unit. The above-mentioned integrated unit may be implemented in the form of hardware or in the form of software functional units.

If the integrated module/unit is implemented in the form of a software functional unit and sold or used as an independent product, it can be stored in a computer-readable storage medium. Based on such understanding, the present disclosure implements all or part of the processes in the above-mentioned embodiment method, and can also be realized by hardware related to computer program instructions, the computer program can be stored in the computer-readable storage medium, and the computer program can implement the steps of the above-mentioned various method embodiments when executed by the processor. The computer program includes computer program code, and the computer program code can be in source code form, object code form, executable file or some intermediate form. The computer-readable medium may include: any entity or device capable of carrying the computer program code, recording medium, U disk, mobile hard disk, disk, optical disk, computer memory, read-only memory (ROM), random access memory (RAM), electric carrier signal, telecommunication signal and software distribution medium. It should be noted that the content contained in the computer-readable medium can be appropriately increased or decreased according to the requirements of legislation and patent practice in the jurisdiction, for example, in some jurisdictions, according to legislation and patent practice, computer-readable media do not include electric carrier signals and telecommunication signals.

The embodiments described above are only used to illustrate the technical solutions of the present disclosure, rather than to limit them; although the present disclosure has been described in detail with reference to the aforementioned embodiments, the one skilled in the art should understand that the technical solutions described in the aforementioned embodiments may still be modified, or some of the technical features may be replaced by equivalents; such modifications or replacements do not deviate the essence of the corresponding technical solutions from the spirit and scope of the technical solutions of the embodiments of the present disclosure, and should all be included in the protection scope of the present disclosure.

1. A method for automatically configuring hardware resources of a driver, comprising:
reading device model information in a configuration file;
matching corresponding hardware resource configuration information and a loading function of the hardware resource configuration information according to the device model information, the hardware resource configuration information comprising description information of the hardware resources; and
executing the loading function of the hardware resource configuration information, and loading the hardware resource configuration information into the driver.

2. The method for automatically configuring hardware resources of a driver according to claim 1, wherein executing the loading function of the hardware resource configuration information, and loading the hardware resource configuration information into the driver comprises:
executing the loading function of the hardware resource configuration information, and invoking an injection function of the driver, a pointer of the injection function of the driver pointing to a position of the hardware resource configuration information; and
loading the hardware resource configuration information into the driver according to the injection function of the driver.

3. The method for automatically configuring hardware resources of a driver according to claim 1, wherein loading the hardware resource configuration information into the driver comprises:
configuring description information of one or more of the hardware resources in the hardware resource configuration information into one or more hardware resource structure bodies; and
loading the one or more hardware resource structure bodies into a structure body of the driver.

4. The method for automatically configuring hardware resources of a driver according to claim 3, wherein the structure body of the driver comprises a data structure body and a configure structure body, and the hardware resource structure bodies comprise a data substructure body and a configure substructure body,
loading the one or more hardware resource structure bodies into a structure body of the driver comprises:
loading the one or more data substructure bodies and the configure substructure bodies into the data structure body and the configure structure body of the driver accordingly.

5. The method for automatically configuring hardware resources of a driver according to claim 1, after loading the hardware resource configuration information into the driver, further comprising:
executing a driving process of the driver in a Zephyr system.

6. The method for automatically configuring hardware resources of a driver according to claim 1, wherein the device model information comprises a device name, a hardware version number, and a hardware interface version number.

7-10. (canceled)

11. A system for automatically configuring hardware resources of a driver, comprising:
a processor; and
a memory storing a computer program, which when executed by the processor, cause the processor to:
read device model information in a configuration file;
match corresponding hardware resource configuration information and a loading function of the hardware resource configuration information according to the device model information, wherein the hardware resource configuration information comprises description information of the hardware resources; and
execute the loading function of the hardware resource configuration information, and load the hardware resource configuration information into the driver.

12. The system for automatically configuring hardware resources of a driver according to claim 11, wherein the processor is further caused to:
execute the loading function of the hardware resource configuration information, and invoke an injection function of the driver, a pointer of the injection function of the driver pointing to a position of the hardware resource configuration information; and
load the hardware resource configuration information into the driver according to the injection function of the driver.

13. The system for automatically configuring hardware resources of a driver according to claim 11, wherein the processor is further caused to:
configure description information of one or more of the hardware resources in the hardware resource configuration information into one or more hardware resource structure bodies; and
load the one or more hardware resource structure bodies into a structure body of the driver.

14. The system for automatically configuring hardware resources of a driver according to claim 13, wherein the structure body of the driver comprises a data structure body and a configure structure body, and the hardware resource structure bodies comprise a data substructure body and a configure substructure body,
wherein the processor is further caused to:
load the one or more data substructure bodies and the configure substructure bodies into the data structure body and the configure structure body of the driver accordingly.

15. The system for automatically configuring hardware resources of a driver according to claim 11, wherein the processor is further caused to:
execute a driving process of the driver in a Zephyr system.

16. The system for automatically configuring hardware resources of a driver according to claim 11, wherein the device model information comprises a device name, a hardware version number, and a hardware interface version number.

17. A computer-readable storage medium having a computer program stored thereon, when the computer program is executed by a processor, the processor is configured to perform a method for automatically configuring hardware resources of a driver, wherein the method comprises:
reading device model information in a configuration file;
matching corresponding hardware resource configuration information and a loading function of the hardware resource configuration information according to the device model information, the hardware resource configuration information comprising description information of the hardware resources; and
executing the loading function of the hardware resource configuration information, and loading the hardware resource configuration information into the driver.

18. The storage medium according to claim 17, wherein executing the loading function of the hardware resource configuration information, and loading the hardware resource configuration information into the driver comprises:
executing the loading function of the hardware resource configuration information, and invoking an injection function of the driver, a pointer of the injection function of the driver pointing to a position of the hardware resource configuration information; and
loading the hardware resource configuration information into the driver according to the injection function of the driver.

19. The storage medium according to claim 17, wherein loading the hardware resource configuration information into the driver comprises:
configuring description information of one or more of the hardware resources in the hardware resource configuration information into one or more hardware resource structure bodies; and
loading the one or more hardware resource structure bodies into a structure body of the driver.

20. The storage medium according to claim 19, wherein the structure body of the driver comprises a data structure body and a configure structure body, and the hardware resource structure bodies comprise a data substructure body and a configure substructure body,
loading the one or more hardware resource structure bodies into a structure body of the driver comprises:
loading the one or more data substructure bodies and the configure substructure bodies into the data structure body and the configure structure body of the driver accordingly.

21. The storage medium according to claim 17, after loading the hardware resource configuration information into the driver, the method further comprises:
executing a driving process of the driver in a Zephyr system.

22. The storage medium according to claim 17, wherein the device model information comprises a device name, a hardware version number, and a hardware interface version number.
